(19) United States
(12) Patent Application Publication
(10) Pub. No.: US 2010/0279039 A1
(43) Pub. Date: Nov. 4, 2010

(54) Heat pipe and method for manufacturing the same

(75) Inventor: Ke-Chin Lee, Taipei (TW)

Correspondence Address: BACON & THOMAS, PLLC, 625 SLATERS LANE, FOURTH FLOOR, ALEXANDRIA, VA, 22314-1176, US

(73) Assignee: Yeh-Chiang Technology Corp., Taipei (TW)

(21) Appl. No.: 12/588,132

(22) Filed: Oct. 6, 2009

(30) Foreign Application Priority Data
Apr. 29, 2009 (TW) 098114131

(51) Int. Cl. B32B 1/08; B32B 37/02; B32B 37/06; B32B 5/02

(52) U.S. Cl. 428/34.1; 156/293

(57) ABSTRACT

A heat pipe comprises a metal tube and a sintered powder layer formed on an inner wall face of the metal tube. The sintered powder layer has a plurality of fine passages extending axially. The sintered powder layer may cover the inner wall face of the metal tube entirely or partially.

### BACKGROUND OF THE INVENTION

1. Field of the Invention

The present invention relates to a heat pipe, especially to a heat pipe having fine passages.

2. Brief Description of the Prior Art

It is known that a heat pipe is a device having high heat transfer capability. The heat pipe is typically formed by a metal tube having a wick structure which is in contact with the metal tube and usually formed on the inner wall face of the metal tube. An inner surface of the wick structure defines a vapor passage. One end of the heat pipe serving as an evaporating segment absorbs heat from a heat source while the other end serving as a condensing segment dissipates heat to a cold source. Liquid working medium returns back to the evaporating segment under capillary action and is evaporated into vapor at the evaporating segment. In turn, the vapor flows to the condensing segment through the vapor passage and is condensed into liquid working medium. The wick structure can be made in various forms, such as a separate metal mesh or sintered metal powder.

In the case of the metal mesh or the sintered metal powder, liquid working medium returns from the condensing segment back to the evaporating segment through a meandering path due to the structure of the metal mesh or the sintered metal powder. Thus, it is expected that straight fine passages can be formed in the wick structure so as to reduce flow resistance of liquid working medium in the wick structure.

### SUMMARY OF THE INVENTION

The object of this invention is to provide a heat pipe comprising a metal tube and a sintered powder layer formed on an inner wall face of the metal tube. The sintered powder layer has a plurality of fine passages extending axially.

Another object of the present invention is to provide a method for manufacturing such a heat pipe.

The sintered powder layer may cover the inner wall face of the metal tube entirely or partially.

The fine passages may be formed by a plurality of fine threads which are embedded axially in a powder layer to be sintered prior to sintering. During the sintering process, the fine threads are dissolved or burned out such that fine passages are formed in the sintered powder layer. The fine threads may be made by resin, plastic, polymer, nylon, cotton, silk, ash-free material, natural fiber, artificial fiber or material capable of being dissolved or burned out at a temperature less than or equal to a sintering temperature.

The above and other objects and advantages of the present invention will become apparent from the following description with reference to the accompanying drawings which illustrate examples of the present invention.

### DETAILED DESCRIPTION OF THE PREFERRED EMBODIMENTS

Now, the preferred embodiments according to the present invention will be described in conjunction with the accompanying drawings. For the sake of convenience, the drawings are not made to scale.

FIG. 1 is a perspective view showing the heat pipe according to the present invention which is indicated by reference 10.

FIG. 2 shows a cross section of the heat pipe 10. FIG. 2a shows a part of the cross section of the heat pipe 10. The heat pipe 10 comprises a metal tube 11 and a sintered powder layer 12 formed on an inner wall face of the metal tube 11. The sintered powder layer 12 has a plurality of fine passages 13 extending in an axial direction.

The method for manufacturing the heat pipe as shown in FIG. 2 will be described as below.

Firstly, a cylindrical plug, having an outer diameter less than an inner diameter of the metal tube, made by stainless steel is provided. Wetted Cu powder is coated on the outer circumferential surface of the cylindrical plug so as to form a first Cu coating. Alternatively, the circumferential surface of the cylindrical plug is wetted by a spraying device, and then the Cu powder is sprayed onto the cylindrical plug such that the Cu powder is attached on the cylindrical plug to form the first Cu coating.

In turn, a plurality of fine threads is disposed on the outer circumferential surface of the first Cu coating in such a manner that the fine threads extend axially and are spaced from each other in a circumferential direction. Optionally, the threads may be wetted for facilitating attachment of the threads on the first Cu coating.

The cylindrical plug formed with the first Cu coating is coaxially inserted in the metal tube. Then, Cu powder is filled in the gap between the inner wall face of the metal tube and the first Cu coating layer.

The metal tube is placed into a heating furnace for sintering. During the sintering process, the fine threads are dissolved or burned out at a temperature less than or equal to a sintering temperature such that a plurality of fine passages are formed in the sintered powder layer.

After sintering, the cylindrical plug is drawn out, and thus a vapor passage is defined by the inner surface of the sintered Cu powder layer.

In this manner, a heat pipe having a sintered powder layer formed with a plurality of fine passages is provided.

Optionally, after the fine threads are disposed in the outer circumferential surface of the first Cu coating, Cu powder is further coated on the outer circumferential surface of the first Cu coating so as to form a second Cu coating layer covering the fine threads. It is also possible to provided further fine threads on the outer circumferential surface of the second Cu coating layer.

Preferably, the fine threads may be made by resin, plastic, polymer, nylon, cotton, silk, ash-free material, natural fiber, artificial fiber or material capable of being dissolved or burned out at a temperature less than or equal to a sintering temperature. In the above embodiment, the cylindrical plug is made by stainless steel. However, it is noted that the cylindrical plug may be made by resin, plastic, polymer, nylon, cotton, silk, ash-free material, natural fiber, artificial fiber or material capable of being dissolved or burned out at a temperature less than or equal to the sintering temperature. Therefore, the cylindrical plug and the fine threads can be dissolved or burned out at the same time.

While this invention has been described with reference to the embodiments, it should be understood that various changes and modifications could be made within the spirit and scope of the inventive concepts described. Accordingly, it is intended that the invention shall not be limited to the disclosed embodiments but have the full scope permitted by the language of the following claims.

### BRIEF DESCRIPTION OF THE ACCOMPANYING DRAWINGS

FIG. 1 shows a perspective view of the heat pipe according to the present invention;

FIG. 2 is a sectional view showing the heat pipe according to the present invention; and

FIG. 2a is a partial enlarged view showing a part of the cross section of the heat pipe according to the present invention;

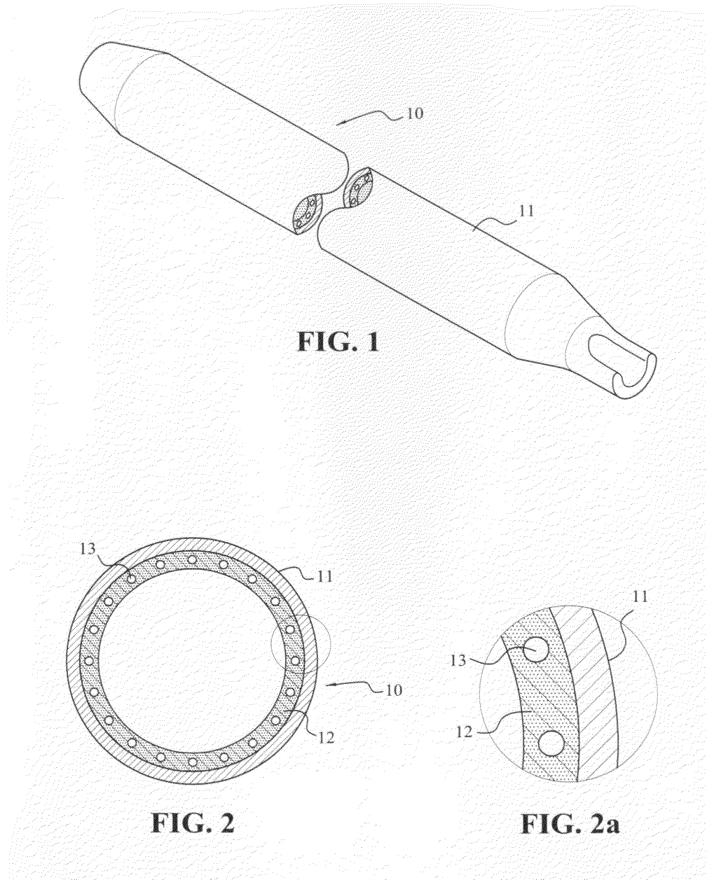

What is claimed is:

1. A heat pipe, comprising a metal tube and a sintered powder layer formed on an inner wall face of the metal tube, said sintered powder layer having a plurality of fine passages extending axially.

2. The heat pipe as claimed in claim 1, wherein said sintered powder layer entirely covers the inner wall face of said metal tube.

3. A method for manufacturing a heat pipe comprising a metal tube and a sintered powder layer formed on an inner wall face of the metal tube, said sintered powder layer having a plurality of fine passages extending axially, said method comprising steps of:
providing a cylindrical plug with an outer diameter less than an inner diameter of said metal tube;
forming a first powder coating on an outer circumferential surface of said cylindrical plug;
disposing a plurality of first fine threads on an outer circumferential surface of said first powder coating;
coaxially inserting said cylindrical plug formed with said first powder coating into said metal tube;
filling a gap between the inner wall face of said metal tube and said first powder coating with powder; and
placing said metal tube in a heating furnace for sintering.

4. The method as claimed in claim 3, further comprising a step of forming a second powder coating covering said first fine threads.

5. The method as claimed in claim 4, further comprising a step of placing a plurality of second fine threads on an outer circumferential surface of said second powder coating.

6. The method as claimed in claim 3, wherein said first fine threads are made by resin, plastic, polymer, nylon, cotton, silk, ash-free material, natural fiber, artificial fiber or material capable of being dissolved or burned out at a temperature less than or equal to a sintering temperature.

7. The method as claimed in claim 3, wherein said cylindrical plug is made by resin, plastic, polymer, nylon, cotton, silk, ash-free material, natural fiber, artificial fiber or material capable of being dissolved or burned out at a temperature less than or equal to a sintering temperature.
